(19) United States
(12) Patent Application Publication
(10) Pub. No.: US 2023/0343150 A1
(43) Pub. Date: Oct. 26, 2023

(54) SYSTEMS AND METHODS FOR FLEET BASED INCREMENTAL JOB ASSIGNMENT

(71) Applicant: Ford Global Technologies, LLC, Dearborn, MI (US)

(72) Inventors: Stuart C. Salter, White Lake, MI (US); Meghan Preiss, Dearborn, MI (US); Brendan Diamond, Grosse Pointe, MI (US); Pietro Buttolo, Dearborn Heights, MI (US); David Brian Glickman, Southfield, MI (US)

(73) Assignee: Ford Global Technologies, LLC, Dearborn, MI (US)

(21) Appl. No.: 17/660,570

(22) Filed: Apr. 25, 2022

(51) Int. Cl. G07C 5/08; G07C 5/02; H04W 4/38; H04W 4/40

(52) U.S. Cl. CPC G07C 5/0808; G07C 5/02; G07C 5/0841; H04W 4/38; H04W 4/40

(57) ABSTRACT

The disclosure is generally directed to systems and methods for receiving a work request for a fleet based incremental assignment system at a vehicle, collecting data from the vehicle during a predetermined period, the data related to a potential vehicle operator for the work request, analyzing the data to determine a performance degradation of the operator throughout the predetermined period, and determining whether the operator is eligible for the work request based on the analysis of the data. The data may be wireless data including monitored data concerning the operator including data related to physical status, level of exhaustion, performance degradation. The data may include interior and exterior sensor data of the vehicle including cameras, radar, and Lidar wherein the sensor data is collected throughout the predetermined period to determine the operator's gait, walking speed, walking behavior to and from the vehicle to evaluate an exhaustion metric for the operator.

### FIELD OF THE DISCLOSURE

This disclosure generally relates to vehicles, and more particularly relates to systems and methods for assigning jobs for a fleet based on incremental differences.

### BACKGROUND

Despite significant developments in the area of fleet management, improvements are possible in determining proper assignments for vehicle operators where assignments do not consider the well-being of the operators for incremental work requests.

It is therefore desirable to provide solutions that address some of the needs associated with the use of fleet vehicle operators in a fleet management system associated with fleet vehicles.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example fleet vehicle with sensors in accordance with the disclosure.

FIG. 2 illustrates a vehicle computer and components in accordance with an embodiment of the disclosure.

FIG. 3 illustrates a decision flow diagram in accordance with an embodiment of the disclosure.

FIG. 4 illustrates a decision flow diagram in accordance with the disclosure.

FIG. 5 illustrates an exemplary incremental job fulfillment process in accordance with the disclosure.

FIG. 6 illustrates a flow diagram for a method in accordance with the disclosure.

### DETAILED DESCRIPTION

### Overview

In terms of a general overview, this disclosure is generally directed to systems and methods for a fleet management system including receiving a work request for a fleet based incremental assignment system at a vehicle, collecting data from the vehicle during a predetermined period, the data related to a potential vehicle operator for the work request, analyzing the data to determine a performance degradation of the operator throughout the predetermined period, and determining whether the operator is eligible for the work request based on the analysis of the data.

In one or more embodiments, a method can include receiving wireless data from interior and exterior vehicle sensors including monitored data concerning the operator such as physical status, level of exhaustion, performance degradation, and receiving metrics concerning the operator such as credentials and hours worked. The sensor data may include GPS sensor data, physiological sensor data, vehicle operation signal data, driving performance data, and route guidance system data. If the operator is determined to be eligible for the work request, the method can include offering the work request to a highest ranking operator of a plurality of eligible operators.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

It should also be understood that the word “example” as used herein is intended to be non-exclusionary and non-limiting in nature. Furthermore, certain words and phrases that are used herein should be interpreted as referring to various objects and actions that are generally understood in various forms and equivalencies by persons of ordinary skill in the art. For example, the word “application” or the phrase “software application” as used herein with respect to a handheld device such as a smartphone, refers to code (software code, typically) that is installed in the handheld device. The code may be launched and operated via a human machine interface (HMI) such as a touchscreen. The word “action” may be used interchangeably with words such as “operation” and “maneuver” in the disclosure. The word “maneuvering” may be used interchangeably with the word “controlling” in some instances. The word “vehicle” as used in this disclosure can pertain to any one of various types of vehicles such as cars, vans, sports utility vehicles, trucks, electric vehicles, gasoline vehicles, hybrid vehicles, and autonomous vehicles. Phrases such as “automated vehicle,” “autonomous vehicle,” and “partially-autonomous vehicle” as used in this disclosure generally refer to a vehicle that can perform at least some operations without a driver being seated in the vehicle. At least some of the described embodiments are applicable to Level 2 vehicles and may be applicable to higher level vehicles as well.

The Society of Automotive Engineers (SAE) defines six levels of driving automation ranging from Level 0 (fully manual) to Level 5 (fully autonomous). These levels have been adopted by the U.S. Department of Transportation. Level 0 (L0) vehicles are manually controlled vehicles having no driving related automation. Level 1 (L1) vehicles incorporate some features, such as cruise control, but a human driver retains control of most driving and maneuvering operations. Level 2 (L2) vehicles are partially automated with certain driving operations such as steering, braking, and lane control being controlled by a vehicle computer. The driver retains some level of control of the vehicle and may override certain operations executed by the vehicle computer. Level 3 (L3) vehicles provide conditional driving automation but are smarter in terms of having an ability to sense a driving environment and certain driving situations. Level 4 (L4) vehicles can operate in a self-driving mode and include features where the vehicle computer takes control during certain types of equipment failures. The level of human intervention is very low. Level 5 (L5) vehicles are fully autonomous vehicles that do not involve human participation.

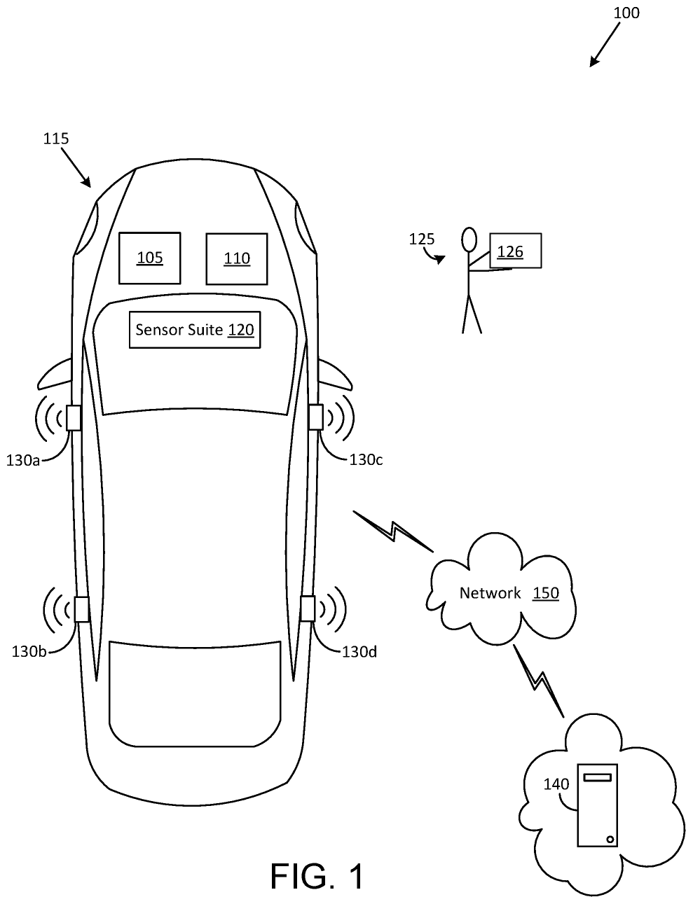

FIG. 1 illustrates an example vehicle 115, or fleet vehicle in accordance with an embodiment of the disclosure. The vehicle 115 may be one of various types of vehicles such as a gasoline powered vehicle, an electric vehicle, a hybrid electric vehicle, or an autonomous vehicle, that is configured as a Level 2 (or higher) automated vehicle. Some components may be carried by a fleet vehicle operator 125, and other components may be accessible via a communications network 150. The components that can be a part of the vehicle 115 can include a vehicle computer 105, and a wireless communication system 110. Vehicle operator 125 is shown delivering a package 126. Components that may be accessible by the vehicle computer 105, via the communications network 150, can include a cloud computing device 140, which may have cloud or network accessible data concerning operator 125 and/or other available operators for work requests that may require immediate attention or the like.

The vehicle computer 105 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.).

The vehicle computer 105 may be used to support features such as embodiments herein related to detecting operator 125 biometrics via sensor suite 120 including exterior and interior cameras and sensors.

The wireless communication system can include a set of wireless communication nodes and/or sensors 130a, 130b, 130c, and 130d mounted upon the vehicle 115 in a manner that allows the vehicle computer 105 to communicate such as vehicle-to-vehicle and vehicle-to-infrastructure type communications. The wireless communication system may use one or more various wireless technologies such as Bluetooth®, Ultra-Wideband, Wi-Fi, ZigBee®, Li-Fi (light-based communication), audible communication, ultrasonic communication, or near-field-communications, for carrying out wireless communications.

Vehicle 115 may include a set of cameras, both interior and exterior cameras, radar, Lidar and the like, and may include sensors capable of detecting physiological data, GPS data and the like. For example, one or more wireless communication nodes and/or sensors 130a, 130b, 130c, and 130d may include cameras or sensors as well as communication technologies.

The vehicle computer 105 can communicate with the cloud computing device 140 via communications system 110 and the communications network 150 to carry out fleet related communications. The communications network 150 may include any one network, or a combination of networks, such as a local area network (LAN), a wide area network (WAN), a telephone network, a cellular network, a cable network, a wireless network, and/or private/public networks such as the Internet. For example, the communications network 150 may support communication technologies such as TCP/IP, Bluetooth®, cellular, near-field communication, ZigBee®, Wi-Fi, Wi-Fi direct, Li-Fi, acoustic or ultrasonic audio communication, Ultra-Wideband, machine-to-machine communication, and/or man-to-machine communication.

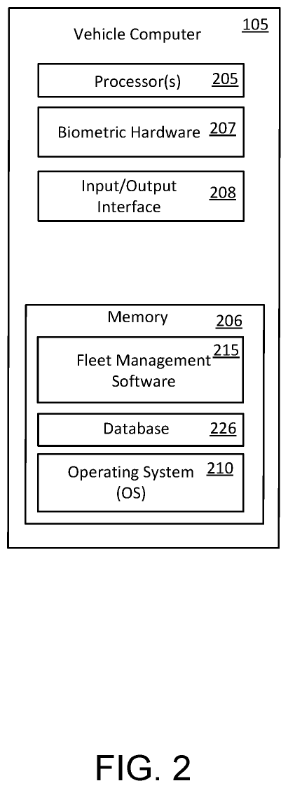

FIG. 2 illustrates some example functional blocks that may be included in vehicle computer 105. As shown, vehicle computer 105 may include a processor 205, biometric hardware 207, input/output interface 208, and memory 206, which is one example of a non-transitory computer-readable medium, and may be used to store an operating system (OS) 210, a database 226, and various code modules such as fleet management system software application 215. Code modules are provided in the form of computer-executable instructions that can be executed by processor 205 for performing various operations in accordance with the disclosure. More particularly, the fleet management system software 215 may be executed by the processor 205 for carrying out various operations in coordination with the vehicle 115 accordance with the disclosure.

Referring back to FIG. 1, vehicle 115 includes a sensor suite 120 with both interior and exterior cameras/sensors, radar and Lidar. In one or more embodiments, the cameras may be used to watch and analyze operator 125. For example, during a predetermined period, such as a workday, the cameras and sensors may analyze operators 125 gait, walking speed, walking behavior to and from vehicle 115. Vehicle 115 and fleet management system software 215 may then use the information for a high level evaluation of operator 125 exhaustion level and may use the evaluation to measure the performance degradation of the operator 125 throughout the day or for a predetermined period.

In one or more embodiments, fleet management system software 215 may recognize and account for a change in gait or walking speed based on identifying that the operator is carrying an object, such as package 126. In one or more embodiments, fleet management system software 215 may use the change in gait or walking speed to make a high level evaluation of exhaustion of the operator and attempt to measure the performance degradation of the user throughout the day or throughout a predetermined period.

More particularly, if the vehicle is being used in a delivery application, for example, as shown in FIG. 1 operator 125 is carrying a package 126. Fleet management system software 215 may have data to determine what package is being held based on a previous scan and database collection of what package is being scanned and requiring delivery to a known location. For example, package 126 weight, size, and shape can be accounted for when analyzing performance of vehicle operator 125.

Further, the total amount of weight and number of packages delivered may be tallied as a reference to data concerning other operators to determine if operator 125 is working beyond normal expectations or mean average for similarly situated operators.

The fleet management system software 215 may also evaluate whether operator 125 is taking a break, talking on the phone, or engaged in other activities while traversing to locations or doing fleet services to ensure fair comparisons are made between similar events and that certain events can be excluded from a calculation of operator exhaustion and analysis determinations.

In one or more embodiments, fleet management system software 215 may evaluate the frequency and occurrences of operator 125 tripping and falling which could be an indication of exhaustion.

In one or more embodiments, fleet management system software may also compare the vehicle operator's gait, walking, and working behavior to other operators or previously stored behaviors to determine whether the operator is injured, such as limping, dragging a foot or the like. The frequency of the vehicle operator's tripping and/or falling which may be an indication of exhaustion. For example, fleet management system software 215 may receive from cameras, previously stored data enabling a comparison of operator 125 gait, walking, or working behavior to other operators or to previously stored behavior. Thus, fleet management software 215 may determine if an operator is injured by noting limping, dragging feet or detecting similar potential injuries or signs of exhaustion.

In one or more embodiments, vehicle 115 may use an interior sensor suite 120 including cameras, GPS sensor, and vehicle operation signals such as speed, use of turn signals and the like to evaluate driving performance, these evaluations determine whether vehicle operator 125 is operating the vehicle properly and not risking injury caused by swerving, and the use of route guidance systems to identify drowsiness, ability to follow route directions, ability to pay attention, and the like to evaluate the vehicle operator's driving performance to determine whether it is deteriorating beyond an undesired level.

In one or more embodiments, sensor suite 120 may include a heartbeat and perspiration monitoring system that may measure the emotional state of the driver/operator 125. These could be sensors embedded in vehicle 115, such as sensor suite 120, or in wearables provided to operator 125.

In one or more embodiments, fleet management system software 215 may track operator 125 throughout the day or during a week or during vehicle operator's tenure at a company, and vehicle 115 may then determine the operator's performance regarding estimated time vs. actual time for assignment completion, warranty/damage/repairs costs related to labor costs and the like to identify effectiveness and efficiency of operator 125, as compared to other operators' completed task. For example, if operator 125 is a driver and a delivery person for a fleet, the time for assignment completion as compared to other operators may be given more weight for effectiveness.

In one or more embodiments, fleet management system software 215 may reference each operator or employee's availability and desire for work requests and access each operator's profile in the fleet to review their qualifications and specialties, reference their effectiveness and efficiency, physical limitations (e.g., unable to mount high equipment such as a ladder), seniority, territory range, intelligence, and other related metrics to rank each available employee regarding who is best suited to take a new job assignment based on the inputs' collected data.

In one or more embodiments, after collecting objective data as described with reference to operator 125, fleet management system software 215 may then input the data, such as key metrics regarding deliveries or other services completed during the predetermined period, such as days or weeks, and subjective data regarding whether operator 125 is seeking for additional assignments or overtime. For example, operator 125 may keep a log or vehicle 115 may generate a log regarding limitations from injuries, jobs they wish to avoid and the like.

Metrics that may be included in such a log or database related to operator 125 may include the following:
a) Number of hours operator 125 has completed per week and in the past, worked in the last week and in the past 24-hour period.
b) Additional hours/work assignments requested by operator 125.
c) Specific days operator 125 has indicated as available for overtime.
d) Number of hours operator 125 used for breaktime during a predetermined period as logged in sensor suite 120.
e) Expectation of operator 125 current assignment completion date.
f) Priority of work request under consideration as compared to operator 125 current work assignment.

As shown, metrics a through f help ensure operator 125 is not provided a work assignment they are incapable of performing for health reasons or due to incapacity from other causes.

Referring now to Table 1, and Table 2, an exemplary metric list illustrates how the metrics may work for operator 125, shown as “Brendan”.

TABLE 1
Operator Brendan (operatory 125)

| | | |
|---|---|---|
| Hours Worked | Last 24 hours | 9 |
| Current Assignment | Estimated Hours Remaining | 2.3 |
| Priority | Current assignment | 4 |
| | New Assignment | 7 |
| User Input | Desired Overtime | Yes |
| | Hours desired | 3 |
| | Day Available for Overtime | M-F |
| Physical Limitations | | less than 60 |
| | | lb Packages |

TABLE 2
Operator Brendan (operator 125)

| Worker/Operator Efficiency | Percentile normalized to other Operators |
|---|---|
| Packages Delivered | 84% |
| Driver Safety | 75% |
| Delivery Issues | 94% |
| Stress Level | Moderate |

Other metrics useful in determining whether operator 125 should be offered a work assignment include data that may be gleaned from data based on user inputs, voice patterns of operator 125 that may indicate lower performance expectations. For example, if operator 125 via voice inputs or other inputs indicates that operator 125 is training another employee, that vehicle 115 has a flat tire or is incapacitated, such information would lower performance expectations.

Fleet management system software 215 can compare the fleet vehicle operator's performance to the worker's and fleets historical averages and other statistical data to measure whether their performance is acceptable or needs improvement. Working slower on certain jobs may be evaluated and directly correlated to customer satisfaction scores.

As shown in Table 2, fleet management software 215 may identify a number of packages delivered/weight of packages delivered/and miles traveled to determine whether vehicle operator 125 is able to work effectively when this system is being used in a delivery service.

Table 2 may include data based on fleet management system software 215 that may create a database and/or a lookup table to determine the schedule of each operator 125 and each vehicle 115 may communicate their current vehicle status (range/state of charge/required repairs) and the operator status (based on metrics listed above) via vehicle-to-vehicle or vehicle-to-infrastructure communications.

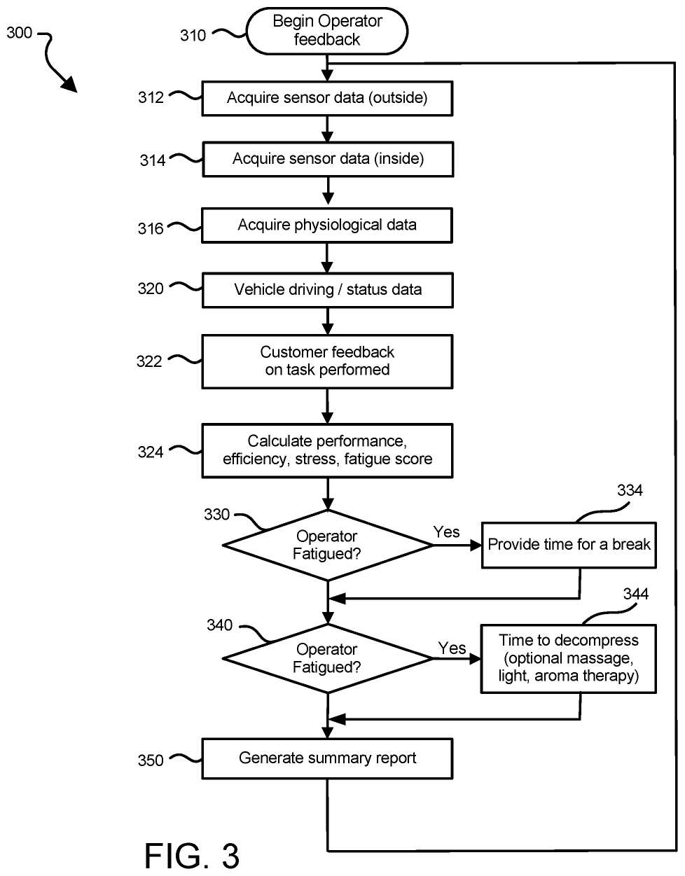

Referring now to FIG. 3, a flow diagram 300 illustrates how a work request may be determined and assigned. As shown, block 310 begins with employee/worker/operator feedback, block 312 provides for acquiring sensor data (outside), block 314 provides for acquiring sensor data (inside). Block 316 provides for acquiring physiological data. Block 320 provides for collecting driving status data. Block 322 provides for collecting customer feedback on a task performed. For example, computer 105 may collect data about different tasks such as deliveries and other services performed by operator 125. Block 324 calculates performance, efficiency, stress, and fatigue scores. Next, at decision block 330, if operator is fatigued is determined then block 334 provides time for a break. Block 340 then asks if the operator is fatigued; if yes then block 344 provides time to decompress by way of an optional massage, light or aromatherapy to the vehicle operator 125. Next block 450 generates a summary report similar to Tables 1 and 2 above.

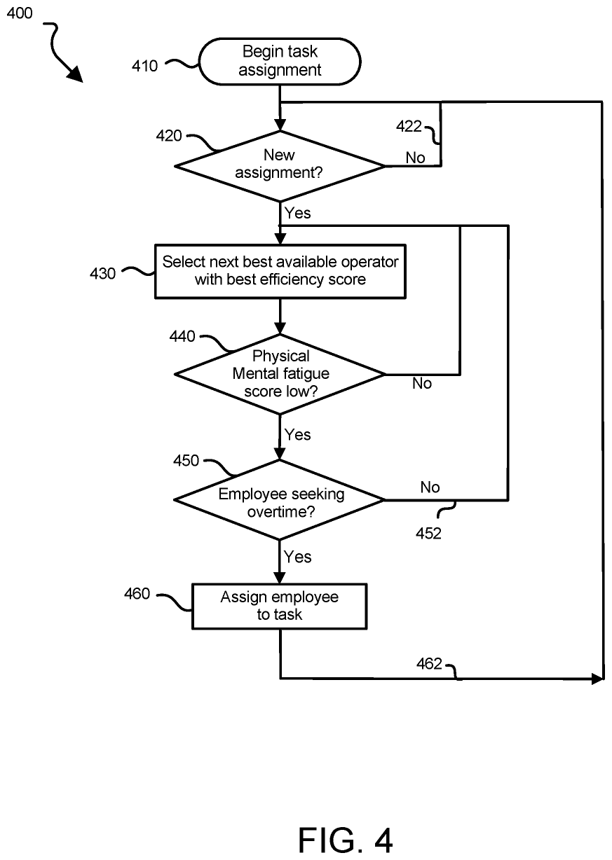

Flow diagram shown in FIG. 4 illustrates a decision flow diagram 400 wherein the tasks are assigned in accordance with fleet management software 215.

FIG. 4 begins with a task assignment at block 410. At block 420, a new assignment is determined. If yes, then assignment proceeds to block 430 and selects the next best operator at with best efficiency score at decision block 430. Next decision block 440 asks whether a physical, mental fatigue score is low. If a physical mental fatigue score is low then the decision goes back to selecting the next best available worker for the best with the best efficiency score at block 430. If yes, then the process loops to the next operator for decision block 440 asking if the physical, mental, fatigue score is low. Next, if the score is high for the task, then the process continues to determine if operator seeks over time at block 450. If yes, the decision goes to block 460 and assigns that operator a task and line 462 returns to the decision block 420 and checks to see if there is a new assignment.

In one or more embodiments, each work request or task assignment 410 is initiated based on a customer's need, such as demand for goods, or other relevant task and the request may be provided to the fleet management software 215. The request may include relevant information such as location, job type, issue/problem experienced, complexity, priority, and the like. The description may include the tasks involved in the assignment such as troubleshooting, what systems will be worked on, basic maintenance, complex repair, and the like. For example, the description may include text, audio, video, and the like so that such information may be used by fleet management software 215 to identify the ideal candidate for the job.

In one or more embodiments, fleet management software 215 may reference each operator's availability and access each operator's profile in the fleet to review their qualifications and specialties, reference their effectiveness/efficiency, physical limitations (e.g., cannot climb ladder), seniority, territory range, intelligence, and other related metrics to rank each available employee regarding who is best suited to take a new work assignment based on all of the inputs.

According to embodiments, fleet management system software 215 may offer the job to an individual who ranks highest on a list regarding all of the inputs listed previously. If no worker meets the desired inputs, less relevant metrics can be removed one at a time or in sets to ensure an employee is available to receive/respond to the request.

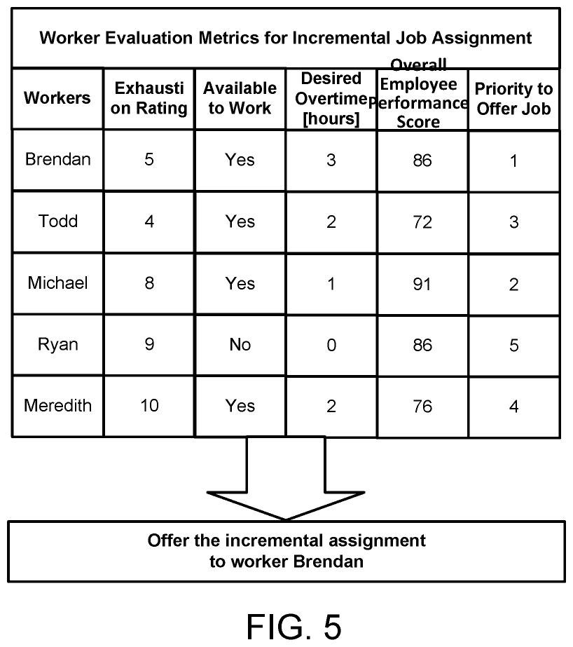

Referring to FIG. 5, a simple flow diagram illustrates a possible incremental job assignment evaluation. As shown, block 510 is a table illustrating different workers, Brendan, Todd, Michael, Ryan and Meredith. Each has an exhaustion rating from 1 to 10. Brendan has a 5 and Todd has a 4, which is a lower exhaustion. All but Ryan are available to work, Brendan has indicated the most number of hours desired for overtime. The overall performance score shows Michael has having the best performance, but only wanting one hour of overtime. Based on priority, Brendan is offered the incremental assignment because the metrics indicate he is less exhausted than Michael and desires more overtime than Michael regardless of Michael's better performance rating. Thus, block 520 shows that the incremental assignment is offered to operator Brendan.

In accordance with one or more embodiments, Brendan can respond to the request and provide a time/day when they can work. Thus, the response does not have to be immediate if no operators are available and the assignment is lower priority.

Brendan may have a choice to take the job, if he denies the opportunity, the fleet management software 215 will offer the job to number 2 person, Michael and then number 3, until an operator is assigned to complete the work task.

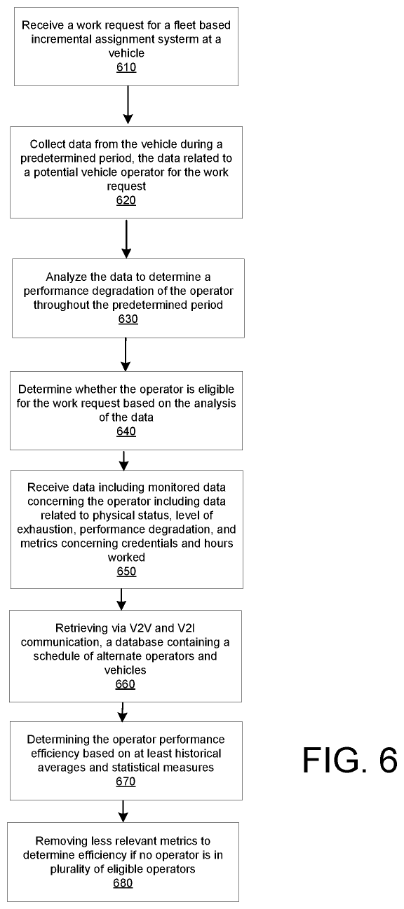

Referring now to FIG. 6, a flow diagram illustrates a method in accordance with an embodiment. As shown, block 610 provides for receiving a work request for a fleet based incremental assignment system at a vehicle. For example, fleet management software 215 may receive a work request. Block 620 provides for collecting data from the vehicle during a predetermined period, the data related to a potential vehicle operator for the work request. For example, operator 125 may be providing data via biometrics, cameras and the like for a predetermined period such as a week, a day or the like. Block 630 provides for analyzing the data to determine a performance degradation of the operator throughout the predetermined period, such as a comparison to previous performances. Block 640 provides for determining whether the operator is eligible for the work request based on the analysis of the data. For example, if an operator is not interested in overtime, it is unlikely the operator will be selected if other operators are interested and available. Block 650 provides for receiving wireless data including monitored data concerning the operator including data related to physical status, level of exhaustion, performance degradation and receiving metrics concerning the operator including credentials and hours worked. For example, wireless data may include cloud connected data from past performance, and database metrics as described above with regard to Table 1 and 2.

The data may include interior and exterior sensor data of the vehicle including cameras, radar, and Lidar wherein the sensor data is collected throughout the predetermined period to evaluate the operator's gait, walking speed, walking patterns to and from the vehicle to evaluate an exhaustion metric for the operator. For example, sensor suite 120 may provide data about the operator and include biometric data. The sensor data can evaluate if the operator is taking a break, talking on the phone, tripping, falling, limping, or dragging feet. The sensor data may include GPS sensor data, physiological sensor data, vehicle operation signal data, driving performance data, and route guidance system data. Block 660 provides for retrieving via vehicle-to-vehicle and vehicle-to-infrastructure communication, a database containing a schedule of alternate operators and alternate vehicles. For example, the retrieving from alternate vehicles may include a current vehicle status including at least a range, state of repair and an operator status.

Block 670 provides determining the operator performance efficiency based on at least historical averages and statistical measures. For example, if an operator such as operator 125, is determined to be eligible for the work request, the method provides for offering the work request to a highest ranking operator of a plurality of eligible operators. For example, as shown in FIG. 5, Brendan is the highest ranking operator. If no operator is in the plurality of eligible operators, the method provides for in block 680, removing less relevant metrics to determine efficiency until an operator is eligible and available. Thus, even if an operator did not request overtime, such an operator may be offered a work request if other criteria such as exhaustion are not impeding the offer.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” “example implementation,” etc., indicate that the embodiment or implementation described may include a particular feature, structure, or characteristic, but every embodiment or implementation may not necessarily include the particular feature, structure, or characteristic. Moreover, such phrases are not necessarily referring to the same embodiment or implementation. Further, when a particular feature, structure, or characteristic is described in connection with an embodiment or implementation, one skilled in the art will recognize such feature, structure, or characteristic in connection with other embodiments or implementations whether or not explicitly described. For example, various features, aspects, and actions described above with respect to an autonomous parking maneuver are applicable to various other autonomous maneuvers and must be interpreted accordingly.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 320, the memory 320, and the memory 520, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving a work request for a fleet based incremental assignment system at a vehicle;
collecting data from the vehicle during a predetermined period, the data related to a vehicle operator for the work request;
determining, based on the data, a performance degradation of the vehicle operator throughout the predetermined period; and
determining whether the vehicle operator is eligible for the work request based on the performance degradation.

2. The method of claim 1, further comprising:
receiving wireless data including data monitored based upon the vehicle operator's eligibility for work, the wireless data indicative of:
physical status, level of exhaustion, performance degradation; and
receiving metrics concerning the vehicle operator including:
credentials and hours worked.

3. The method of claim 1, wherein the data includes interior sensor data and exterior sensor data of the vehicle received from one or more of cameras, radar, and Lidar, wherein the exterior sensor data is collected throughout the predetermined period, and further comprising:
determining one or more of the vehicle operator's gait, walking speed, walking behavior to and from the vehicle; and
determinine an exhaustion metric for the vehicle operator.

4. The method of claim 3 further comprising determining, based on the exterior sensor data, whether the vehicle operator is taking a break, engaging on their phone, tripping, falling, limping, and/or dragging feet.

5. The method of claim 3 wherein the data includes one or more of GPS sensor data, physiological sensor data, vehicle operation signal data, driving performance data, and route guidance system data.

6. The method of claim 2 wherein the received metrics concerning the vehicle operator includes:
vehicle operator work schedule and work log.

7. The method of claim 1 further comprising:
retrieving, via vehicle-to-vehicle and vehicle-to-infrastructure communication, a database containing a schedule of alternate operators and alternate vehicles; and
retrieving from alternate vehicles a current vehicle status including at least a range, state of repair and an operator status.

8. The method of claim 1 further comprising:
determining operator performance efficiency based on at least historical averages and statistical measures.

9. The method of claim 8 further comprising:
if the vehicle operator is determined to be eligible for the work request, offering the work request to a highest ranking operator of a plurality of eligible operators; and
if no operator is in the plurality of eligible operators, removing less relevant metrics to determine efficiency until an operator is eligible and available.

10. The method of claim 9 further comprising:
accessing a plurality of operator profiles to determine efficiency metrics including qualifications, specialties, past efficiencies, physical limitations, seniority, territory, intelligence, wherein the metrics contribute to a rank among the plurality of eligible operators.

11. An apparatus for a fleet based assignment system comprising:
a memory;
a processing circuitry coupled to the memory, the processing circuitry configured to operate in a vehicle, the processing circuitry operable to:
receive a work request for a fleet based incremental assignment system at the vehicle;
collect data from the vehicle during a predetermined period, the data related to an operator of the vehicle for the work request;
analyze the data to determine a performance degradation of the operator throughout the predetermined period; and
determine whether the operator is eligible for the work request based on the analysis of the data.

12. The apparatus of claim 11, wherein the processing circuitry is further operable to:
receive wireless data including monitored data concerning the operator, the wireless data including data related to physical status, level of exhaustion, and/or performance degradation; and
receive metrics concerning the operator, the metrics including credentials and hours worked.

13. The apparatus of claim 11, wherein the data includes interior sensor data and exterior sensor data of the vehicle received from one or more of cameras, radar, and Lidar, wherein the exterior sensor data is collected throughout the predetermined period, and wherein the processing circuitry is further operable to:
determine the operator's gait, walking speed, walking behavior to and from the vehicle, and
determine an exhaustion metric for the operator.

14. The apparatus of claim 13 wherein the processor circuitry is further operable to determine, based on the exterior sensor data, to determine whether the operator is taking a break, talking on the phone, tripping, falling, limping and/or dragging feet.

15. The apparatus of claim 13 wherein the exterior sensor data includes one or more of global positioning sensor (GPS) data, physiological sensor data, vehicle operation signal data, driving performance data, or route guidance system data.

16. The apparatus of claim 12 wherein the processing circuitry is operable to receive metrics concerning the operator, including operator work schedule and work log.

17. The apparatus of claim 11, wherein the processing circuitry is further operable to:
retrieve via vehicle-to-vehicle and vehicle-to-infrastructure communication, a database containing a schedule of alternate operators and alternate vehicles; and
retrieve from alternate vehicles a current vehicle status including at least a range, state of repair, and an operator status.

18. The apparatus of claim 11, wherein the processing circuitry is further operable to:
determine the operator performance efficiency based on at least historical averages and statistical measures.

19. The apparatus of claim 18, wherein the processing circuitry is further operable to:
offer the work request to a highest ranking operator of a plurality of eligible operators if the operator is determined to be eligible for the work request; and
remove less relevant metrics to determine efficiency until an operator is eligible and available if no operator is in the plurality of eligible operators.

20. The apparatus of claim 18, wherein the processing circuitry is further operable to:
access a plurality of operator profiles to determine efficiency metrics including qualifications, specialties, past efficiencies, physical limitations, seniority, territory, or intelligence, and wherein the efficiency metrics contributes to a rank among the plurality of eligible operators.
